(19) United States
(12) Patent Application Publication
(10) Pub. No.: US 2008/0014569 A1
(43) Pub. Date: Jan. 17, 2008

(54) Teacher Assisted Internet Learning

(75) Inventors: Kent Holiday, Ten Sleep, WY (US); Sam Merrill, Ten Sleep, WY (US); Aaron Jensen, Seattle, WA (US); Jacob Lewallen, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Eleutian Technology, LLC, Ten Sleep, WY (US)

(21) Appl. No.: 11/697,485

(22) Filed: Apr. 6, 2007

Related U.S. Application Data
(60) Provisional application No. 60/790,097, filed on Apr. 7, 2006.

(51) Int. Cl. G09B 3/00

(52) U.S. Cl. 434/351; 434/350

(57) ABSTRACT

The present invention provides a learning system wherein students are provided with course content via the Internet and perform learning activities online. The students can be paired with teachers and other students as needed for learning. The system provides monitoring of students' activities with the learning material, and provides ranking of student abilities and needs, teacher abilities and weakness, and content effectiveness, and can match teachers and students based on student needs and teacher abilities to meet those needs. The system allows for dynamic updating of content, and provides suggested content based on effectiveness. Video conferencing with teachers can be scheduled.

### CROSS-REFERENCES TO RELATED APPLICATIONS

The present application claims priority from U.S. Provisional Application No. 60/790,097, filed Apr. 6, 2006, and is incorporated herein by reference in its entirety for all purposes.

### BACKGROUND OF THE INVENTION

The present invention is related to Internet-based online teaching and in particular to the integration of human teachers with online teaching.

Many learners (students) are stuck in the role of observer, often watching what goes on around them without participating. In addition to language frictions, students may also lack the experience and/or confidence to participate. Traditional online teaching methods simply track student progress and loop a student back to a checkpoint if they fail. This somewhat isolated learning environment does not promote or otherwise encourage motivation to learn.

### BRIEF SUMMARY OF THE INVENTION

The present invention provides a learning system wherein students are provided with course content via the internet and perform learning activities online. The students are paired with teachers and other students as needed for learning. The system provides monitoring and ranking of student abilities and needs, teacher abilities and weakness, and content effectiveness, and can match teachers and students based on student needs and teacher abilities to meet those needs. The system allows for dynamic updating of content, and provides suggested content based on effectiveness.

Features of the present invention include:
Multilingual: The present invention provides a database for support with multiple languages. This facilitates teaching by allowing for interactions with students in native language at the same time, and alternatively in multiple languages at the same time, as is appropriate.
Dynamic progress: The present invention provides immediate report card/scores to the students to gauge their progress.
Matching student skill sets: The present invention can match student needs to teacher abilities. A database algorithm is provided to match students, track student progress, and track teacher abilities.

The present invention provides includes at least the following aspects:
1. Track what a student has reviewed, test scores, work scores, and provide these to a teacher. The teacher knows what a student ahs spent time on, what the student does well and has problems with. The system can provide suggestions as to what a student needs. Student will hit milestones which triggers a message that the student is ready for a video conference with a teacher. The student submits a request for a conference, a teacher may accept it, and the student may initiate the video conference. A student may request a videoconference on their own. Students requesting a conference may immediately be paired with an available teacher.
Triggers for a videoconference may be: a student can not progress beyond a certain point, or the student may have completed up to a certain point.
2. Teachers are provided with areas to address with students. The database system provides problem areas in lessons to work on with students. Adaptive learning within the system is routing a student within a learning system. A student is matched to teachers according to student needs and teacher abilities.
3. Teachers can mark or edit or update Lesson Content to improve the learning, based off of results and feedback. Teacher can not which things work or do not work and content is rated by usefulness. Teacher note problems and solutions related to student type, location, etc.
4. Built in grading and reports based on progress allow review of progress, grades, status at any time. Reports can be used to see why a student is not passing a certain point in the lessons.
5. Teachers or students can review previous conferences, lessons, all graded items, etc as desired. This can be used to determine why a student is not passing a current lesson point.
6. Students are placed with a teacher best suited to their skills, level, or deficiencies. The system monitors scores, time to complete lessons, etc to determine what a student needs. Information about a students progress may be used to adjust the learning process or material and to pair a student with teachers for video conferences.
The system also monitors teacher effectiveness at teaching specific lessons or skills based on student progress, time used, feedback and review scores. Teacher are rated up or down on particular lessons or skills so that each teacher is rated for the skills and lessons they have taught. Student needs are then matched with teacher effectiveness for a particular topic.
7. Teachers are provided with the skills, examples, activities to teach a particular lesson or skill. For video conferences, teachers are provided with the material relevant to a specific student problem. Teacher effectiveness is tracked and used to select specific teachers according to student needs. Teacher can train through a similar system to increase their abilities. There is a teacher pool of many teachers. The system tracks and rates teachers on specific topics and determines which teachers are the most effective at teaching particular concepts. Students are matched to the most effective teacher at solving their particular problem. The most effective path for teaching is selected as a student progresses through material as the students are routed to the most effective teachers for each particular problem.
Classroom settings: A video conference can also be between one teacher and many students. The system can select a group of students with similar needs, problems, strengths, etc. and can match to a teacher best suited to the particular needs.
8. Video conferencing can also be student to student. A student who is bad at A and good at B can be matched to a student who is bad at B and good at A for a conference. Pairing can also be based on similar interests or backgrounds. Students can be left to talk freely, given specific topics to discuss, review lessons, etc. Students are allowed to see strengths and weaknesses in other students and allowed to discuss challenges in lessons and tests.
The system provides dynamic rating of student and teacher strength and weakness and dynamic pairing of students and teachers according to strength and weakness and needs. Teaching content is also dynamic as it can be edited by teacher and is rated according to effectiveness. During conferences, content is suggested to teachers or students according to effectiveness.
9. Students provide feedback on lessons, teachers, examples, techniques. The system records feedback and uses it to rate the effectiveness of the material, which is used to suggest material most effective at solving a particular problem.
10. The system provides notification to parents, boss, etc. to the students progress. Responsible persons may log on and view records of students assigned to them. They can view scores, watch sessions, tie into live sessions, provide feedback to the system, view where students have spent time.

### BRIEF DESCRIPTION OF THE DRAWINGS

FIG. 1 is an overview of the teacher-assisted Internet learning method of the present invention.

FIG. 2 is a high-level description of the process flow of an illustrative embodiment of the present invention.

FIGS. 2A-2D are screenshots of a typical placement exam.

FIG. 3 is a high-level description showing an example of the process flow for student registration.

FIGS. 3A-3E are illustrative screenshots for course selection.

FIG. 4-7 show processing for obtaining student record data from an external student registration database.

FIG. 8 is a high-level description for the process flow for notifying a student of a video session.

FIG. 9 is a high-level description for the process flow for assisting a teacher with a live video session.

FIG. 10 shows a high-level system block diagram of an illustrative embodiment according to the present invention.

FIGS. 11A-11F are screenshots illustrating an example of scheduling a live video conference.

### DETAILED DESCRIPTION OF THE INVENTION

The following definitions are applicable in the context of the present invention:

A. General terms
Instructional Item—Quiz, test, assignment, an so on; anything that evaluates performance.
Skill—Anything the content is intended to teach or that the students should acquire by the end of a lesson, course, and so on.
Need—Skills that the students lack or are deficient in.

B. Per-Student Metrics
Time—How long the student took to complete the instructional item.
Proficiency/Performance—How well the student did on the instructional item on some scale.
Teacher Evaluation—The teacher's evaluation of the Student's performance during the video conference sessions.
Peer Evaluation—Other student's evaluations of the Student's during their peer sessions.

C. Per-Teacher Metrics
Effectiveness—Change in performance of the students after the teacher has interacted with them. For example, more effective teachers produce better performances in students.
Student Evaluation—The student's evaluation of the Teacher during video conference sessions.
Evaluation Accuracy—The correlation between the teacher's subjective evaluation and the student's subsequent performance on instructional items.
Trainings—The number of trainings a teacher has gone through in a particular Skill.

D. Student Content Metrics
Effectiveness—Change in performance of students who consume the content, measuring how well they understood a particular concept before and after in order to understand how well the content helped.
Teacher Rating—Cumulative rating of content by teachers (higher weightings for those teachers who are most effective).

E. Teacher Content Metrics
Effectiveness—Change in performance of students who consume the content (via the teacher), measuring how well they understood a particular concept before and after in order to understand how well the content helped.
Teacher Rating—Cumulative rating of content by teachers (higher weightings for those teachers who are most effective).

The following procedural capabilities are provided:

A. Dynamic Teacher/Student Matching
Problem
   I am a student who is deficient at skill A (I “need” skill A) and am at a certain point in my progress along the lesson plans.
Parameters
   Performance—how well the student has done in other related skills, prior skills and the skill in question.
   Content recently consumed by the student to aid in their performance.
Weight
   Higher the worse the student has performed in this area.
   Higher if the area has never been reviewed with a teacher.
   Higher for problem areas, areas of habitual failure.
Process
   Sort teachers based on effectiveness/Availability (Filtered by student—Now, 4 hrs, 2 days, etc.) @ meeting needs*weights
Output:
   Pick topmost teacher

B. Dynamic Teacher/Teacher Matching
Problem
   I am deficient at teaching skill A and there is a need for teachers that can teach skill A and so I will observe another teacher teaching skill A well in order to prove my effectiveness.
Define Parameters
   All teacher effectiveness metrics (their past performance at meeting each specific need)
   Demand for teachers that are proficient at teaching each skill. i.e. Number of students who are in the middle of learning each skill and number who will soon need to learn a skill, etc. . . .
Define Weights
   Fewer teachers there are at meeting those needs and the more students needed, the higher the weight. OR More trainings they've had, less the weight, also, the better they are at it, the less the weight.
Process
   Sorting by weights
   Pick conversation from sorted output that addresses the given need
Note: Greedy nature, we feel a greedy approach to selection is better with a large number of teachers as it's likely we'll have teachers who are good at fulfilling specific needs rather than needing average teachers rather than excellent ones.

C. Dynamic Peer Matching (1 to 1 and 1 to many)
Problems
   1. Examining needs and proficiency and joining students based on complementary needs and proficiency.
   2. For generating peer pairs: Student who needs skill A is joined with student who has a higher proficiency of skill A and vice versa for skill B.
   3. For generating groups of peers, study groups or classes: Students of similar needs and of similar proficiency are joined together.
Process

D. Dynamically Suggesting Content
Problems
   1. With a wide selection of available content, choose the most appropriate content in a given situation to produce a high return on performance.

E. For Students
Student content are lessons, tests, quizzes, games, articles, etc anything consumed by students to learn skills/fulfill needs.
Parameters
   1. Effectiveness of the content—how well it taught other students a set of skills (based on their existing proficiencies?)
   2. Students' needs/proficiencies—skills and proficiencies the students have.
   3. Teacher ratings—the ratings given to the content by all teachers.
Outputs
   1. A piece of selected content with the highest effectiveness for fulfilling needs that the student has.
Process
   1. First take a subset of the content that fulfills the student's needs
   2. Sort the content by the parameters.
   3. Choose the content that is at the top of the list.

F. For Teachers
Teacher content is created by the teachers and is for teacher consumption in leading lesson plans.
Parameters
   1. Effectiveness of the content—how well other teachers were able to teach students using the content.
   2. Students' needs/proficiencies—skills and proficiencies the students have.
   3. Teacher ratings—the ratings given to the content by all teachers.
Outputs
   1. Selecting a piece of content with the highest effectiveness for teaching their students their needs.
Process
   1. First take subset of content that fulfills the student's needs.
   2. Sort the content by the parameters.
   3. Allow the teacher to pick content they're comfortable using from the top several contents.

G. For Peer Group/Classroom
Parameters
   1. Effectiveness of the content—how well other teachers were able to teach students using the content.
   2. Students' needs/proficiencies
Outputs
   1. Selecting a piece of content with the highest effectiveness for teaching the group of students their collective needs.
Process
   1. Sort content based on student's needs.
   2. Allow teacher to pick content if there is one, otherwise allow students to vote on content or just give them the topmost.

H. Need/Proficiency Pairs
Parameters
   1. Student needs for a set of skills (A and B)
   2. Student proficiencies for the same set of skills (A and B)
Outputs
   1. Two areas of content, one which meets the needs of student A and meets the proficiency of student B and vice versa.
Process
   1. Choose 2 contents, one that the first student is proficient at and the second student needs, another that the first student needs and the second student is proficient in by sorting by the parameters.

According to the present invention, a student may register online for classes at any time. No set schedule is required for the classes. Registration grants students access to the system, and the student may work through the materials at their own pace.

A student may be placed in classes by various means, such as by taking a placement examination or based on previous completed courses.

After course placement and registration, a student is granted access to course materials and is allowed to progress through the materials. It is appreciated that the course materials depend on the subject being taught.

The computer system and course materials may be multilingual. The system may provide a database with multiple languages, which can interact with students in their native language and handle multiple languages at once. The system can match students with other students and teachers having the same native language as may be necessary or beneficial.

As a student works through the course materials, the student may schedule video conferences with teachers. These video conferences are often one on one video conferences between the student and teacher. Additionally, other types of video conferences may be utilized, such as between a teacher and multiple students, and between students.

Video conferences may be scheduled for a variety of reasons. If a student progresses through the course materials to a certain point, the student may be notified that a conference should be set up with a teacher. Alternatively, a student may be prompted to set up a conference based on scores on an assignment or test, based on the inability to understand or pass a certain point in the material, etc.

Video conferences thus become an important part of the course, and allow students to receive personalized attention from teachers. During a video conference, a teacher may present examples or learning exercises relevant to the student's needs.

Teachers or students can review previous conferences, lessons, all graded items, etc as desired. This can be used to determine why a student is not passing a current lesson point.

A student thus progresses through the course materials, and upon completion of one course, may register for any subsequent courses.

A significant aspect of the present invention is the use of a computer system to monitor and manage the learning process. The system provides a variety of functions as described herein.

One use of the computer system is to track the student progress through the course work. The system monitors and records many aspects of the student's study and progress through a course. The system monitors the students study habits and progress. The system tracks where a student spends time while studying and reviewing lesson material. The system also tracks the student's scores on assignments, activities, and tests.

Thus, the system is able to determine the strengths and weaknesses of a particular student. The system contains information as to which assignments or which concepts the student had trouble with, as well as in which areas the student performed well. Built in grading and reports based on progress allow review of progress, grades, status at any time. Reports can be used to see why a student is not passing a certain point in the lessons.

The system can provide notification to parents, boss, etc. regarding the student's progress. Responsible persons may log on and view records of students assigned to them. They can view scores, watch sessions, tie into live sessions, provide feedback to the system, view where students have spent time. The system can provide immediate report cards and scores provided to students or authorized persons to gauge progress. Such reports may not be limited to test scores only, but may include information regarding study habits, video conferences, etc.

Information regarding a student's progress may be used to determine whether or not a student would benefit from a video conference, or is ready to advance to the next course or curriculum.

The system can track what a student has reviewed, test scores, work scores, and provide these to a teacher. The teacher knows what a student has spent time on, what the student does well and has problems with. The system can provide suggestions as to what a student needs. Student will hit milestones which triggers a message that the student is ready for a video conference with a teacher. The student submits a request for a conference, a teacher may accept it, and the student may initiate the video conference. A student may request a videoconference on their own. Students requesting a conference may immediately be paired with an available teacher.

Triggers for a videoconference may be that a student can not progress beyond a certain point, or the student may have completed up to a certain point.

Teachers are provided with areas to address with students. The database system provides problem areas in lessons to work on with students. Adaptive learning within the system is routing a student within a learning system. A student is matched to teachers according to student needs and teacher abilities.

Similarly, monitoring student progress, scores, and the like may allow the system to find problems with the course material. Comparing the information from many students allows the system to determine if a particular part of the course material is inadequate to teach the desired concepts. These results may be used to modify the course materials. Materials which are inadequate may be marked for revision. Additionally, examples or illustrations of the course materials may be marked as to their effectiveness. The examples and materials may be ranked according to their effectiveness, and the most effective materials may be presented to students.

The system may also allow for feedback regarding the materials. The system may allow students and others to rate the materials and to comment on why the materials were or were not effective in learning the desired subject. Such comments may be used by system administrators or teachers to revise the materials.

Students provide feedback on lessons, teachers, examples, techniques. The system records feedback and uses it to rate the effectiveness of the material, which is used to suggest material most effective at solving a particular problem.

Teachers can mark or edit or update Lesson Content to improve the learning, based off of results and feedback. Teacher can note which things work or do not work and content is rated by usefulness. Teacher note problems and solutions related to student type, location, etc.

In a manner similar to how students are tracked, the system may also track teachers to determine teacher effectiveness. Video conferences between students and teachers may be monitored and tracked by the system to determine how much time was required and how much improvement was made by the student following the conference. Students may also be able to rate and comment on the teacher effectiveness and the effectiveness of examples and other content provided by the teacher.

The system thus allows for the ranking of both the teacher and the materials presented by the teachers. The system can track what the teacher is good at teaching and what a teacher is bad at teaching.

The system utilizes the ratings and information stored to manage the learning process for the students. The course content may be dynamically managed to improve the content. Content which has shown to be ineffective in teaching the students may be replaced or modified. Content which has been effective in teaching the students may be automatically presented to the students at the appropriate point in the course. Tracking the effectiveness of the content for each student allows the system to determine the overall effectiveness of the content in teaching, and allows the system to rate content according to effectiveness and present the most effective content to a student.

Tracking student progress and difficulties allows the system to customize content to each particular student. The system may track the particular difficulties a student is having and present effective content to the student. Additionally, when a video conference is needed, the system can match a student's particular difficulties to a teacher who is effective in teaching the needed concepts and schedule video conferences between the student and the desired teacher.

Students are placed with a teacher best suited to their skills, level, or deficiencies. The system monitors scores, time to complete lessons, etc to determine what a student needs. Information about a student's progress may be used to adjust the learning process or material and to pair a student with teachers for video conferences.

The system also monitors teacher effectiveness at teaching specific lessons or skills based on student progress, time used, feedback and review scores. Teachers are rated up or down on particular lessons or skills so that each teacher is rated for the skills and lessons they have taught. Student needs are then matched with teacher effectiveness for a particular topic.

The system may also present the student's study and progress information to the teacher, and present highly ranked examples or supplemental material to the teacher to cover during the video conference.

Teachers are provided with the skills, examples, activities to teach a particular lesson or skill. For video conferences, teachers are provided with the material relevant to a specific student problem. Teacher effectiveness is tracked and used to select specific teachers according to student needs. Teacher can train through a similar system to increase their abilities. There is a teacher pool of many teachers. The system tracks and rates teachers on specific topics and determines which teachers are the most effective at teaching particular concepts.

Students are matched to the most effective teacher at solving their particular problem. The most effective path for teaching is selected as a student progresses through material as the students are routed to the most effective teachers for each particular problem.

Classroom settings may also be utilized. A video conference can thus be between one teacher and many students. The system can select a group of students with similar needs, problems, strengths, etc. and can match to a teacher best suited to the particular needs.

If a group of students have trouble with similar concepts, the system may identify all of these students and arrange a group videoconference between these students and a teacher which is effective in teaching these concepts.

Video conferencing can also be student to student. A student who is bad at A and good at B can be matched to a student who is bad at B and good at A for a conference. Pairing can also be based on similar interests or backgrounds. Students can be left to talk freely, given specific topics to discuss, review lessons, etc. Students are allowed to see strengths and weaknesses in other students and allowed to discuss challenges in lessons and tests.

The system provides dynamic rating of student and teacher strength and weakness and dynamic pairing of students and teachers according to strength and weakness and needs. Teaching content is also dynamic as it can be edited by teacher and is rated according to effectiveness. During conferences, content is suggested to teachers or students according to effectiveness.

The system may also track the types of examples or materials which a particular student found effective and correlate the materials in such a manner. The system may track the examples and materials useful to particular students and determine correlations between what types of examples are useful to particular types of students. Thus the system can provide examples and materials to aid in teaching a student according to the student's previous learning patterns or other information.

The system may determine that students living in England found example A useful in learning concept 1, example F useful in learning concept 2, and example c useful in learning concept 3, while students living in the United States of America found example B useful in learning concept 1, example c useful in learning concept 2, and example G useful in learning concept 3. Similarly, the system may determine a student who found example B useful in learning concept 1 will likely find example A useful in learning concept 2 and example D useful in learning concept 3, while a student who found example A useful in learning concept 1 will likely find example C useful in learning concept 2 and example B useful in learning concept 3.

By so monitoring the entire learning process, including students, teachers, course materials, supplemental materials, etc., the system allows for the most efficient learning process for each particular student. When a student has trouble with a particular concept, the most relevant supplemental material may be presented to the student. When a teacher conference is desired or needed, the system can match a student to a teacher according to the strengths and weaknesses of the student and the effectiveness of the teacher in teaching the specific concepts needed by the student.

Each individual student is thus routed through the most efficient teaching pathway for themselves individually. They are presented with the concepts most relevant to their needs and are taught by the teacher most qualified to help with their particular needs.

The course content may be constantly monitored via feedback, ratings, and student progress monitoring and dynamically adjusted to increase the priority ratings for effective content and by editing less effective content.

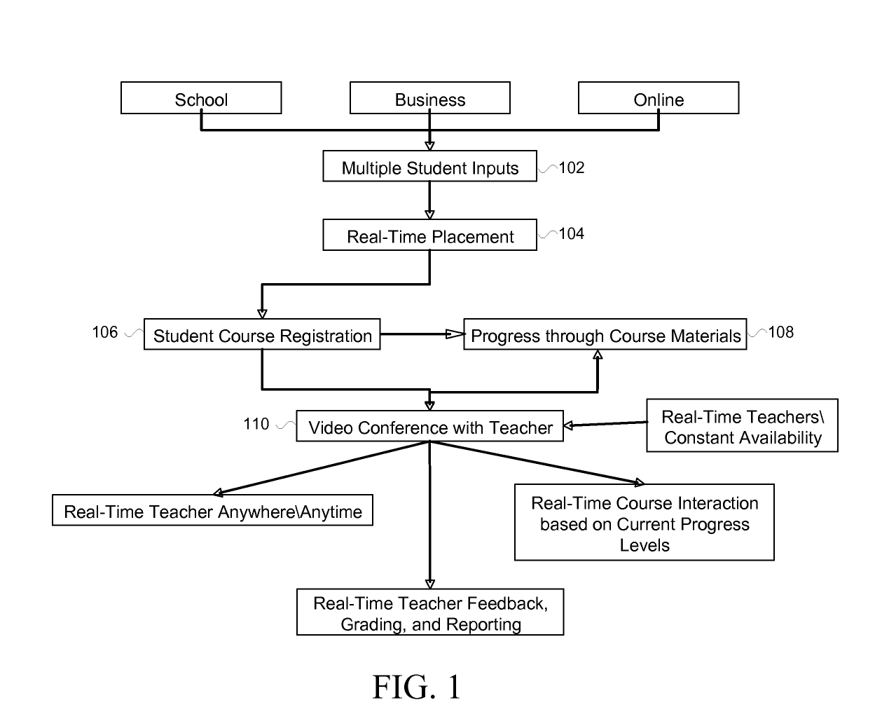

Referring to FIG. 1, various aspects of computer-based teacher-assisted learning in accordance with the present invention discussed above are shown. As indicated in the figure, the present invention is applicable to a variety of classes of users, including: schools and learning institutions in general; business concerns interested in providing further education for their employees, for example, international businesses might want their employees to improve their foreign language skills; and the general public who may access the present invention over the Internet. The present invention provides for online (e.g., internet-based) learning, and can accommodate multiple student types (102) who have different and unique needs and goals for a learning system.

The invention provides real-time placement (104) of the a newly registered student. Registration (106) grants students access to the system, allowing the student to work through the materials at their own pace. After course placement and registration, a student is granted access to course materials and is allowed to progress through the materials (108). The student's progress is monitored, as he/she progresses through the material. Based on the student's progress through the material, recommendations can be made to schedule a live video conference with a teacher (110).

Live teachers are an integral aspect of the presentation invention. Teacher-users are always available to the student (24 hours a day, seven days a week). The live video conference can be conducted with a teacher-user irrespective of the student's geographic location. Teachers provide real-time course interaction based on the student's progress, and importantly provide valuable real-time feedback, grading, and reporting to the student to allow the student to assess his weaknesses and so that he can direct his efforts more effectively than without such feedback.

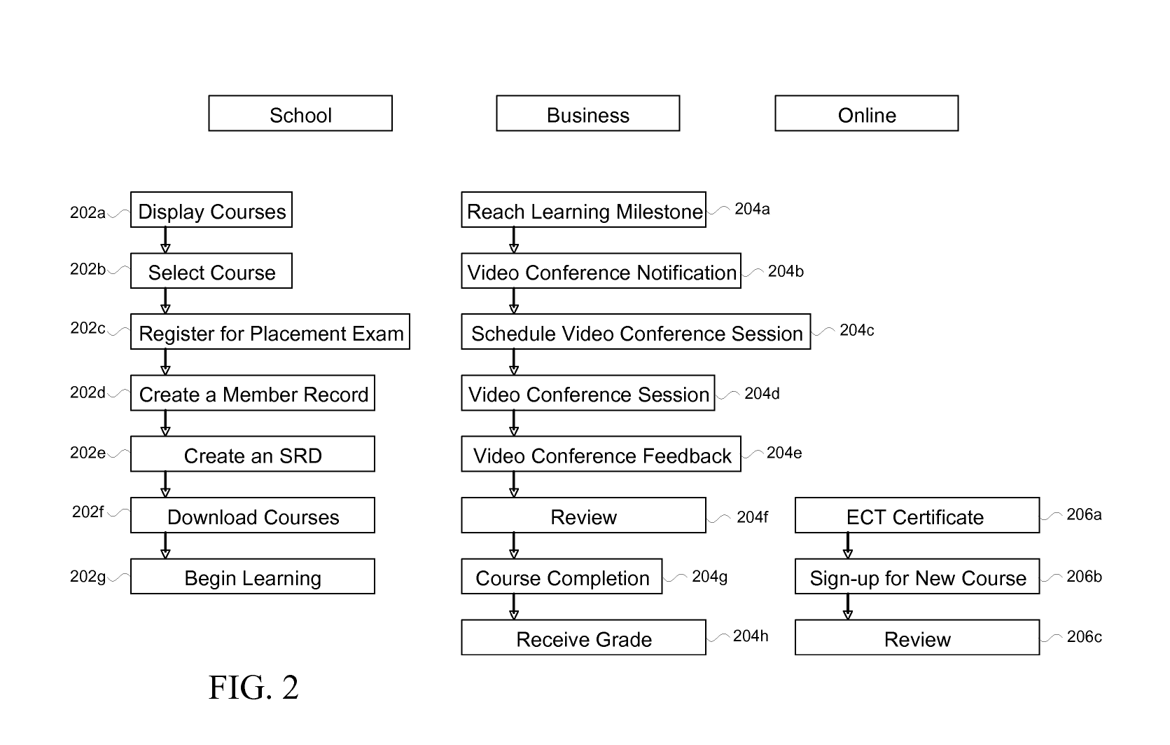

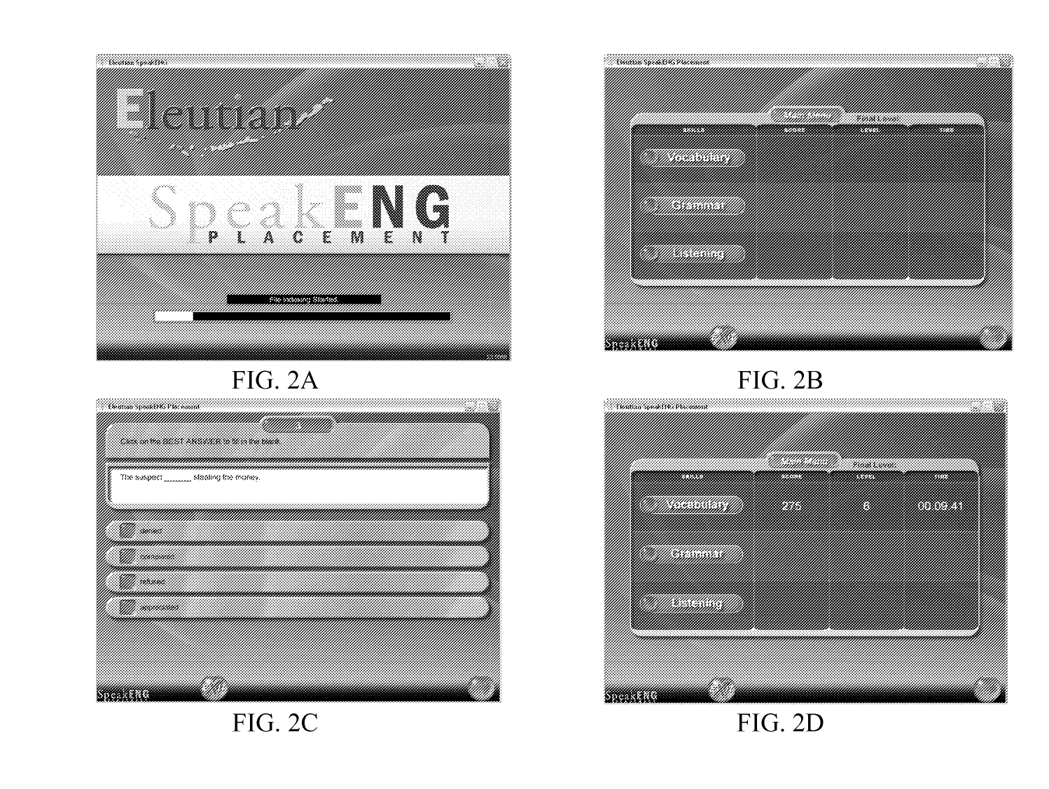

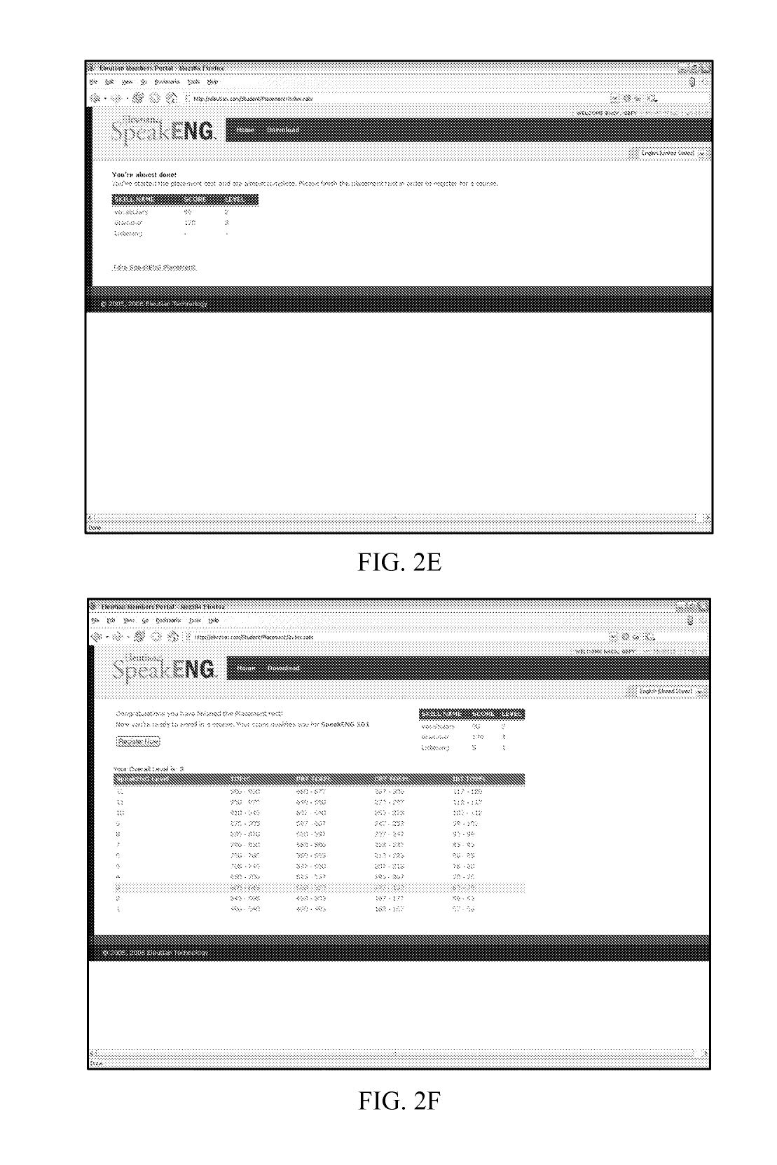

FIG. 2 shows a high-level flow for the learning process in accordance with the present invention. Courses available to a student are presented to the student-user (step 202a). The student-user typically accesses the system via the Internet using his computer running a suitable browser. When the student selects a course (step 202b), he is then given a placement exam (step 202c). Upon completion of the placement exam, a member record is created (step 202d) along with a student data record (step 202e). A member record contains the student's personal information; e.g., name, email, phone, address, etc. A student data record contains information about the lessons the student has taken, his progress through the lessons, and evaluations of his learning (e.g., test grades, live video conferences, teacher evaluations, and so on). The student is then ready to download course material (step 202f) and begin learning (step 202g).

An aspect of the present invention is that the student's progress through the learning material is monitored, and when certain milestones are detected (step 204a), live video conferences with a teacher-user (step 204b) can be recommended. Typically, conferences are recommended because the student has not made sufficient progress as determined from testing, by monitoring his activity with the courser material, and so on. The student and teacher can then arrange for a video conference (step 204c). A scheduling database can be provided to facilitate the exchange of the student-user's and the teacher-user's scheduling information.

A live video conference session between the student and the teacher is then conducted (step 204d). Feedback from the conference can be entered into the database (step 204e); additional detail of the various databases in an embodiment of the present invention is given below. This feedback includes feedback from the student as well as the teacher. The student's feedback allows the teacher to review (step 204f) his teaching performance and about the course material, thus allowing for refinement of the course material as well as the teacher's teaching methodology. The student completes the course (step 204g) by taking examination(s) to prove his proficiency. The student's grade is also provided (step 204h) to the student. In an embodiment of the present invention, the student's student data record can be provided to other personnel. For example, an employer of the student might want to be able to assess the student's progress and proficiency, especially if the employer has paid for the learning.

Upon completion of the course material, a certificate can be issued (step 206a). For example, in an embodiment of the present invention, the course material relates to learning English. In an embodiment of the present invention, an ECT Certificate is issued. The ECT certificate (English Certification Test) is a test created and licensed by the Brigham Young University. Upon completion of a course, the student is allowed to register for another course (step 206b). For example, the student can register for an additional courses such as “SpeakENG Business” programs once he has completed the “SpeakENG Academic” course load and taken a certification exam.

FIGS. 2A-2F are illustrative screenshots showing the placement exam process. FIG. 2A shows a startup screen for the placement exam. The user interface is the student-user's browser running on his computer. FIG. 2B shows three testing categories used to establish the student's placement in an English-language course. FIG. 2C shows a typical question in the exam; here, the question is a fill-in-the-blank type of question. The student-user selects an answer (e.g., by “clicking” on one of the buttons displayed on the left-side of the answer choices). The user can change his answer, and then clicks on the continue arrow at the bottom right corner of the display to submit an answer. Upon completion of the placement test for the selected category, the student user's score is displayed for that category, FIG. 2D.

The student-user can log out of the system and complete the placement exam at a later time. FIG. 2E illustrates that when the student logs back into the system, the progress of his placement exam is indicated. A link entitled “Take SpeakENG Placement” is displayed, allowing the student continue with the placement exam. Note that until the student completes the exam, no other choice is provided. FIG. 2F shows an example where the student has completed the placement exam. Scores of the individual categories are displayed in the upper right portion of the display. The main display portion shows the student's ranking; in the example shown, the student has a Level 3 ranking. Note that a new link, “Register Now” is now displayed. This link allows the student to register for the course material.

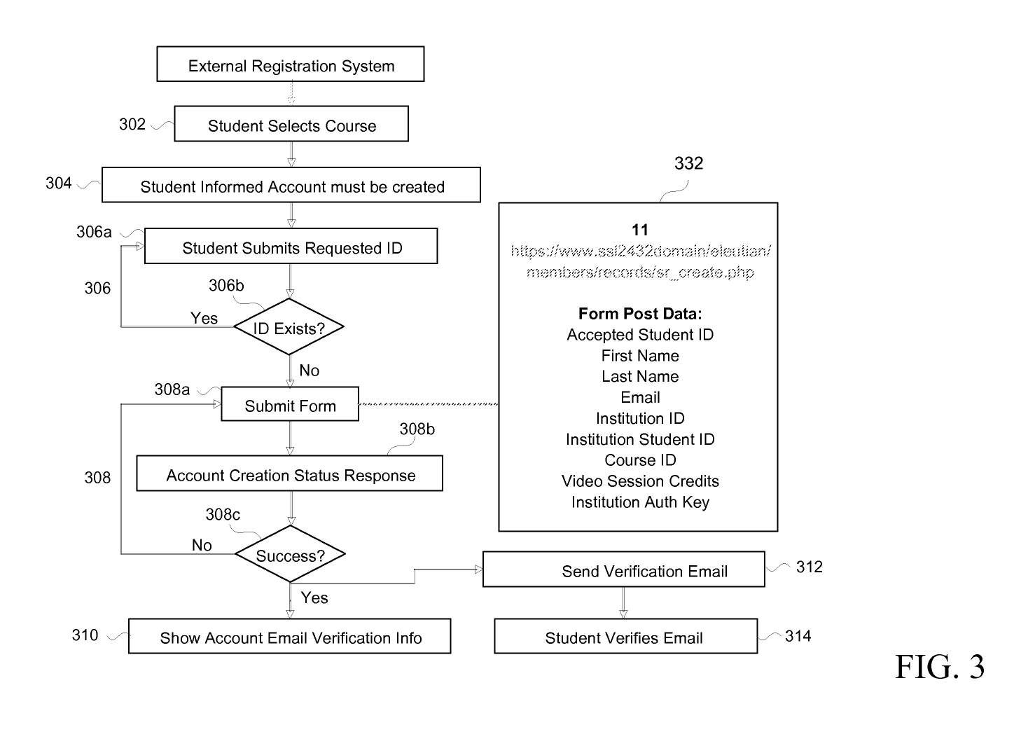

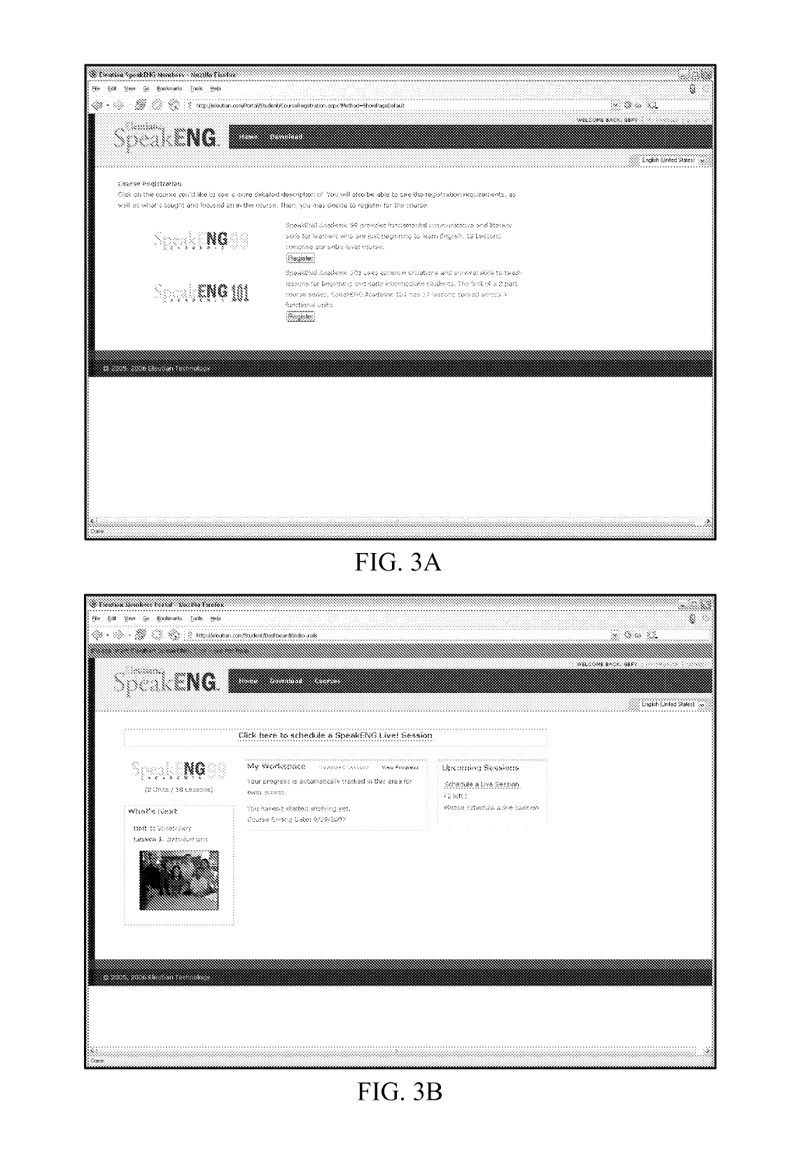

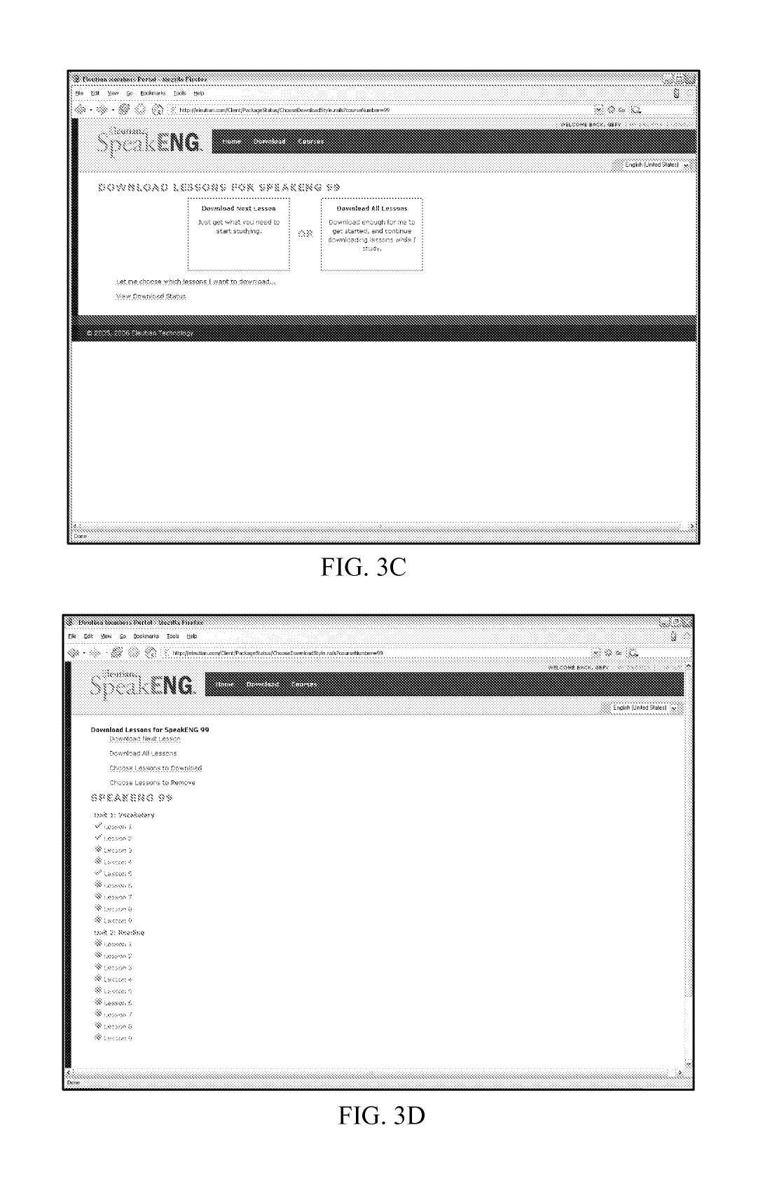

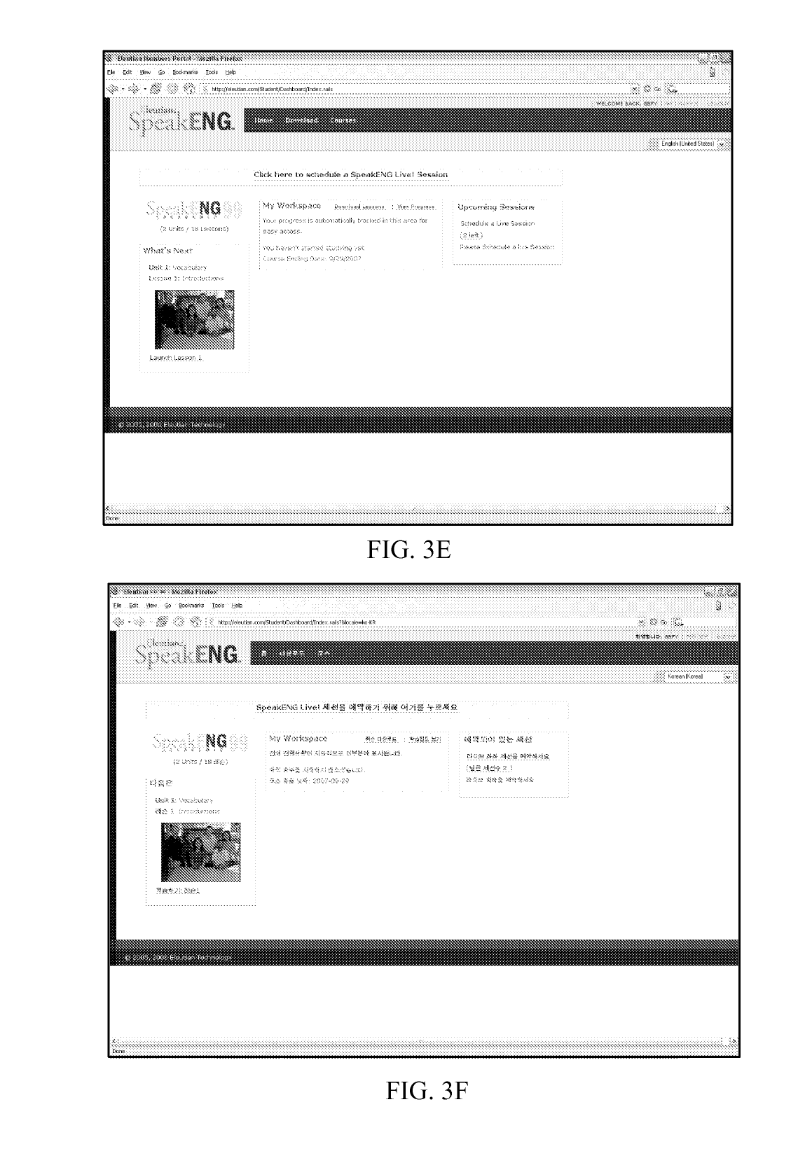

FIG. 3 shows steps involved in the student registration process. Interaction with and External Registration System (step 302) may be needed where student information is being managed by another system. For example, students at a university may already signed up for courses and their information is in that school's database. In order to avoid requiring that students repeat the tedious registration process, the present invention can interface with the school's system to obtain its student information.

After having completed the placement exam, the student-user can proceed with course selection (step 302). A student account is then created (step 304). This typically occurs early on when the student has decided to register to take courses. Creating a student account involves obtaining a student ID (step 306), used to log onto the system, and involves requesting an ID from the student (step 306a) and verifying if the selected ID is already in use by another student (step 306b). After an acceptable ID is provided, student data is obtained (step 308). This involves obtaining data (step 308a) such as shown in form 332 and verifying (step 308b). Upon a successful entry of the student's data (step 308c), the student's email is verified (step 310) and a verification email is sent (step 312). The student then verifies the email address (step 314), for the student can click a link in a verification email that is sent to the student to confirm that it is a valid email address before account creation completes.

Recall from FIG. 2F that the link “Register Now” is presented to the student-user, since he had completed the placement exam. If the student clicks on this link, he is presented with the display shown in FIG. 3A, allowing him to register for a course. FIG. 3B shows a display that is presented to the student (referred to as the “dashboard”) when he logs onto the system. The dashboard includes a portal called “My Workplace” that allows the student to download lessons or view his progress through the lesson material. A “download lessons” link allows the student that he can download the lessons for a particular course. FIG. 3B indicates that none of the lessons for the course have yet been downloaded. An “Upcoming Sessions” portal allows the student to schedule a live video conference, discussed in more detail below. When the student clicks on the “download lessons” link, the display of FIG. 3C is presented, allowing the student to download all or just selected ones of the lessons. FIG. 3D shows that the student-user selected lessons 1, 2, and 5. If the student-user clicks on the “Home” link, he will be returned to the dashboard (FIG. 3E), which will now inform him that lesson 1 is available, in the “What's Next” portal.

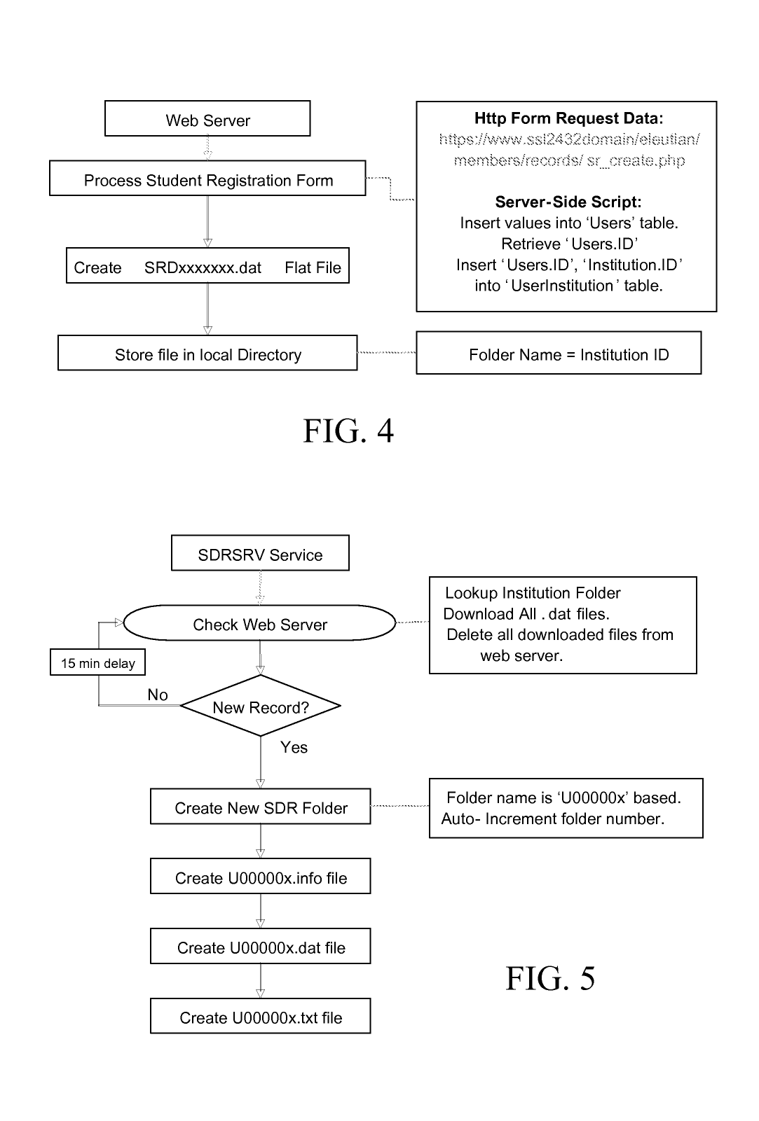

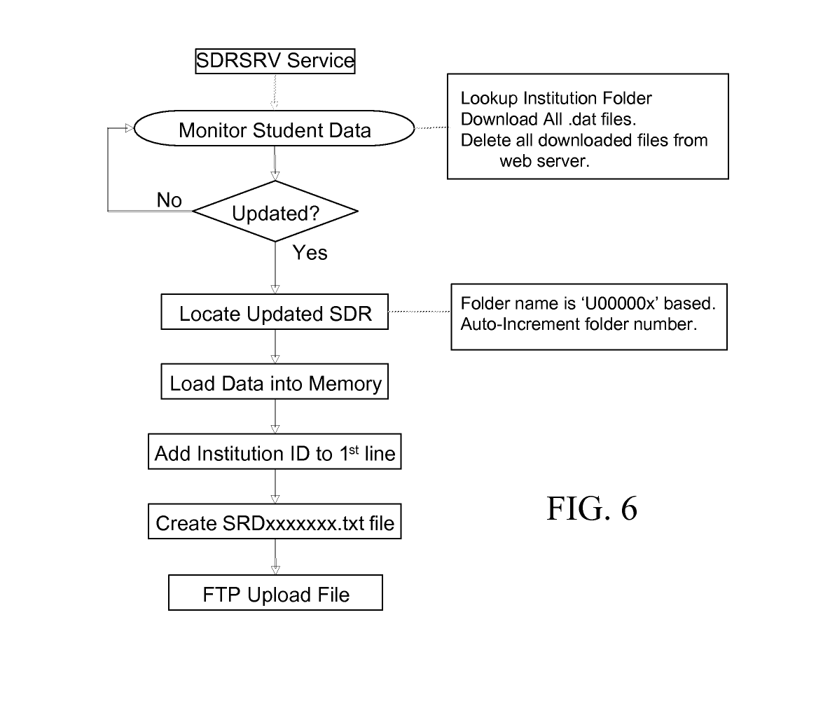

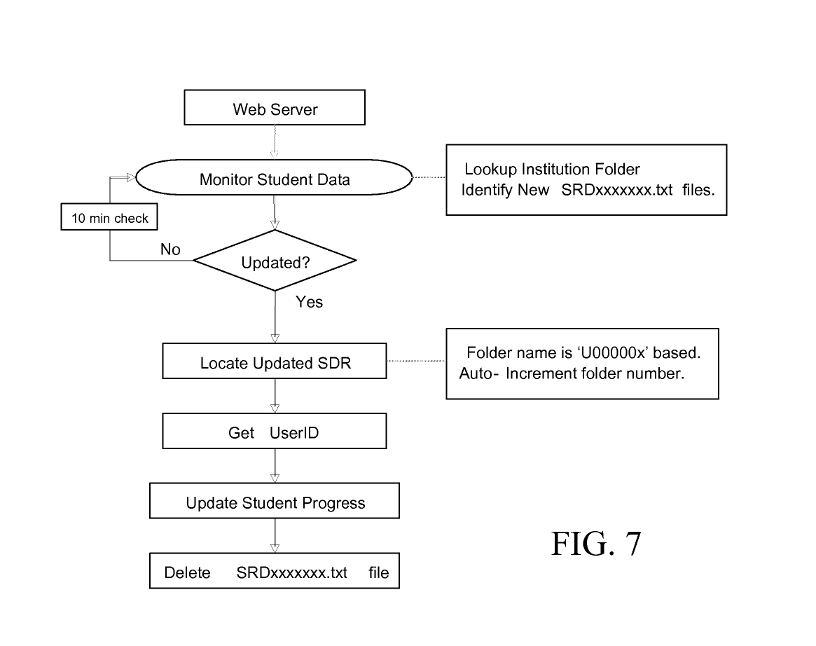

FIGS. 4-7 illustrate some basic flows for interfacing with an external registration system (e.g., an educational institution) mentioned in connection with the description of FIG. 3. A brief overview follows: FIG. 4 shows the creation of student record data (SRD) for each student. FIG. 5 depicts the initial download of SRD information from the external registration system. FIG. 6 shows updating the SRD information by synchronizing with updates made in the external registration system. As a student progresses through the learning material, information relating to the student's progress through the learning material is associate with the student. FIG. 7 illustrates an example of making updates to a student's SRD with that student's progress information. The foregoing figures show the storage and management of SRD information as flat files. In another embodiment of the present invention, the SRD information is maintained in a database.

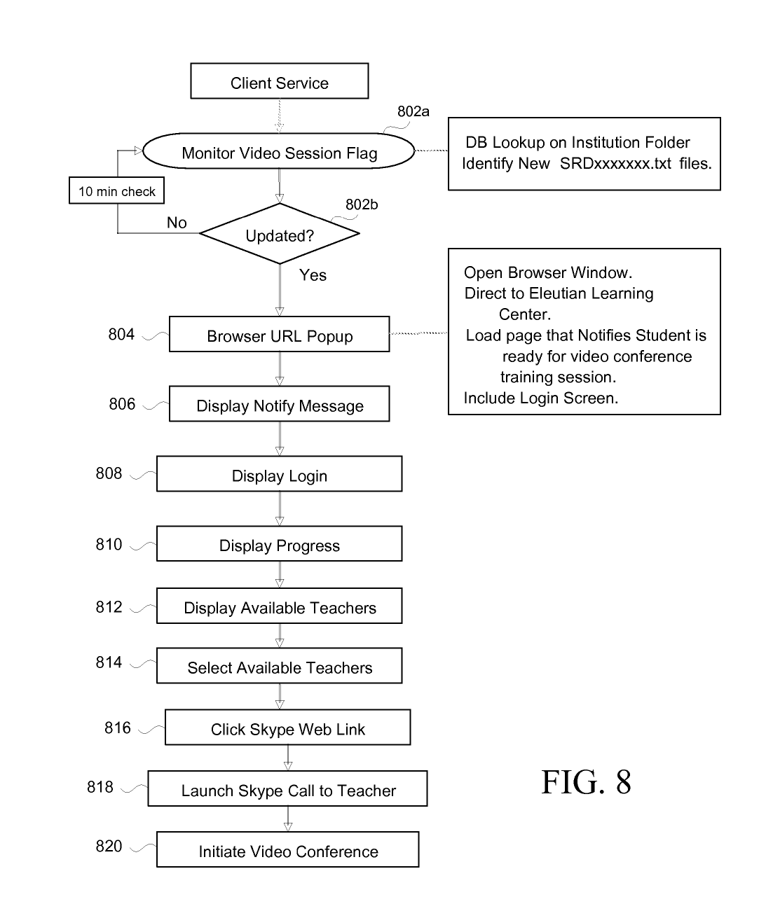

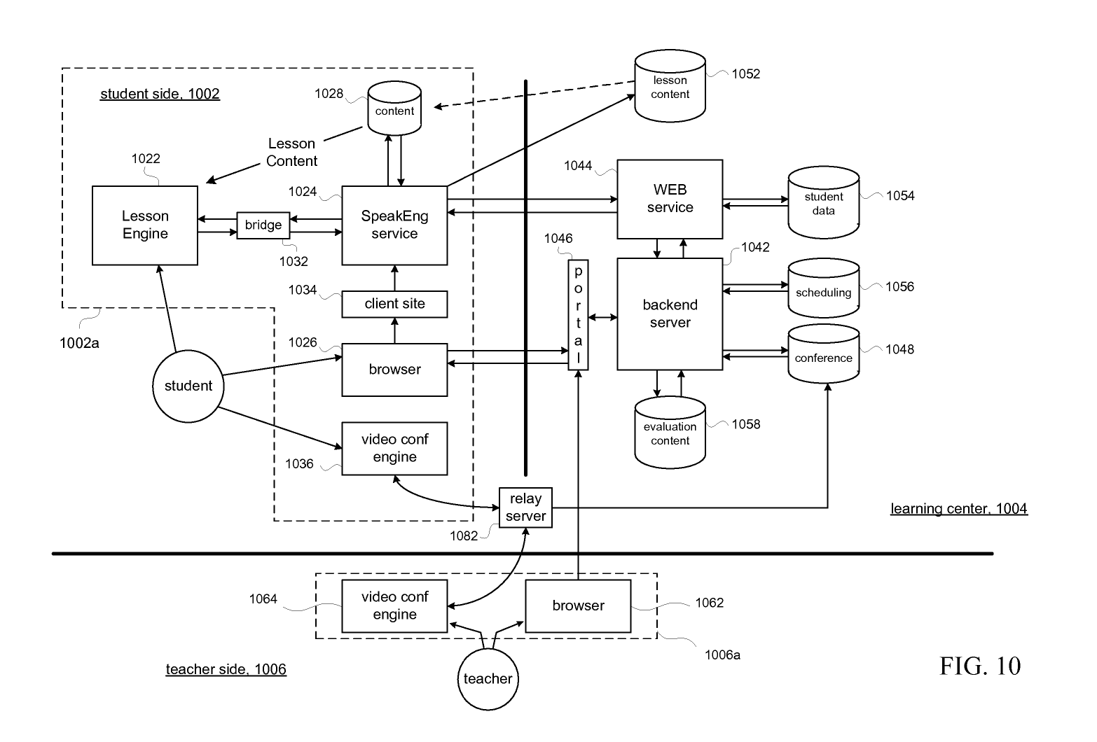

FIG. 8 describes processing for notifying the student-user of a video session. The processing shown in this figure occurs in the student's computer and, in a particular embodiment of the present invention shown in FIG. 10, is performed by the SpeakENG Service 1024. A video session flag is monitored (step 802a) periodically to determine (step 802b) whether it has been updated to indicate that a video session is ready to commence. In an embodiment of the present invention, this involves inspecting a database to identify whether a new SDR file has been created.

If a video session is ready to commence, then a URL pop-up will be pushed to the student's browser (FIG. 10). This will open up a window in the student's browser and connect to the learning center. A page will load to notify the student of the video conference, including the display of a login screen (step 808). Various displays will be presented showing the student's progress (step 810) and listing available teachers (step 812). When the student selects an available teacher (step 814), he will establish a connection (steps 816-820) to begin the video conference. In the particular embodiment shown in FIG. 10, the video conference is hosted by Skype™, although any video conferencing solution is suitable.

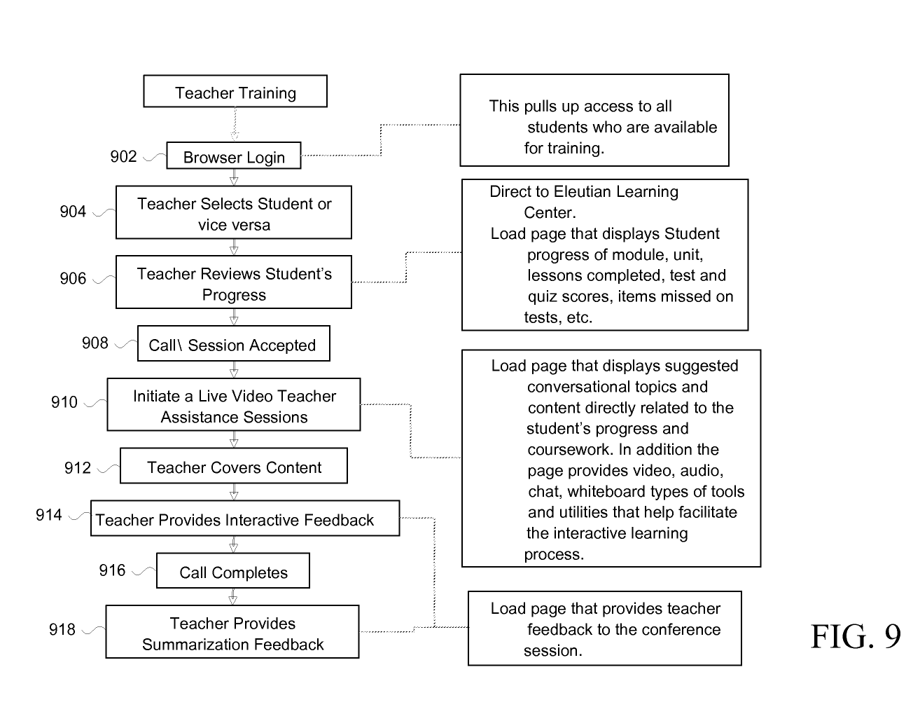

FIG. 9 shows processing conducted by a teacher-user for conducting a video conference. When the teacher log into the learning center via her browser (step 902), the browser will display a list and provide access to all students who are available for training. A selection is made for a video conference with one of the students, step 904. This selection can be made by way of the teacher selecting from the list of available students. Alternatively, a student can previously have selected this particular teacher.

Prior to conducting the video conference, the teacher can access the databases (FIG. 10) maintained by the learning center of the students' progress and pull up (step 906) the selected student's progress data. The teacher can place a telephone call to the student to begin the session, or the student can call in. Typically, the former is conducted in order not to incur the cost of calling the teacher. If the teacher's request for a video conference is accepted (step 908), then both the teacher and the student will take steps to initiate the video conference.

In the particular embodiment of the present invention as illustrated in FIG. 10, Skype™ provides the video conferencing capability, although it is understood that any video conferencing solution is suitable. Typically, digital video cameras Conferencing tools include video and audio demonstrations, chat capability, whiteboard facilities, and the like. A display of suggested conversational topics and content directly related to the student's progress can be provided to facilitate the video session. The teacher and student then conduct the video conference (step 912), including providing interactive feedback to the student as he works through the material with the teacher (step 914). At the conclusion of the video conference (step 916), the teacher can summarize the lesson and provide other feedback to the student (step 918).

FIG. 10 shows a high-level system block diagram of an illustrative embodiment according to the present invention. In accordance with an embodiment of the present invention, the teacher-assisted learning environment comprises a student-user component 1002, a learning center component 1004, and a teacher-user component 1006. The learning center 1004 is implemented as a Web site that can be accessed by students via a suitable browser. Students can register to take courses offered by the learning center 1004, and then access the learning material contained in the learning center. An important aspect of the present invention is the provisioning of access to teacher-users, including scheduling live video conferences with teacher-users.

The student-user component 1002 comprises a computer 1002a comprising components of a typical computer such as a data processing unit, memory, storage (e.g., hard disk drive), a display, and input devices such as a keyboard and a pointing device (e.g., mouse). Stored on the computer 1002a are various software components. A suitable browser 1026 executing on the student's computer 1002a provides Internet to the Web site hosted by the learning center.

The Client Site 1034 represents various web pages necessary to allow the student-user to access the learning center via the web browser 1026. For example, web pages are provided to launch a Lesson Engine 1022, to initiate a download of Lesson Content from the server Lesson Content store 1052, to access the student's data records, and so on.

The Lesson Engine 1022 is configured to operate the student's computer 1002a to access and display Lesson Content to the student-user. Lesson Content is stored locally in a Lesson Content data store 1028, and typically comprises XML files, MP3 data, and .mov data; but can include any other media suitable for displaying lessons and interaction with the lessons. In one embodiment, the Lesson Content data store 1028 is storage on the hard disk drive of the student's computer 1002a. Alternatively, it may be more suitable that the Lesson Content data store 1028 is contained in a shared local data store that is accessible by two or more students.

The Lesson Engine 1022 is launched from the web browser 1026, and mediates interactions between the student and the Lesson Content. The Lesson Engine 1022 monitors and records the student's interactions with the Lesson Content. For example, the Lesson Engine 1022 will monitor the student's access activity of the Lesson Content (length of time spent at each page, number of repeated accesses to a particular page, how many questions in the lesson content the student answered, which lessons the student worked on, which games the student played as a part of the content, which skills (e.g., grammar, vocabulary, listening, communication, pronunciation) the student worked on, and so on.

A bridge 1032 is provided between the Lesson Engine 1022 and client software referred to as the SpeakENG Service 1024. The bridge 1032 is a lightweight program component that is responsible for passing student activity data and a few other things (e.g., student's username, what course/unit/lesson to display, etc.) between the SpeakENG Service 1024 and Lesson Engine 1022. The SpeakENG Service 1024 comprises the programming for providing a suitable user interface to access the Lesson Content and to perform the related lesson-access activities on the student's computer 1002a. The SpeakENG Service 1024 communicates over the Internet with a Web service 1044 in the learning center 1004 to send the student activity data to a Backend Server 1042.

A video conference engine 1036 can be launched on the computer 1002a when a live video conference between the student-user and the teacher-user is conducted. The video conference engine 1036 receives video and possibly audio from the teacher for display on the student's computer 1002a. The video conference engine 1036 can also receive digital video from a digital camera aimed at the student and send the captured video to the teacher. Allowing the teacher to view the student can provide important information to the teacher, especially in the case where language learning is involved. Oftentimes, it is important to be able to see how the student forms the sounds in order to give properly teach the student. The video conference engine 1036 can also receive digital audio input from a microphone that the student speaks into and send the captured audio to the teacher. Alternatively, the audio connection between the student and teacher can be by a telephone or some other suitable communications channel. In an embodiment of the present invention, the video conference engine 1036 is a Skype™ client.

In an embodiment of the present invention, the learning center 1004 is presented to the student as a web site. The web site can be hosted on one or more server machines. The Backend Server 1042 represents the main workhorse of the learning center 1004. The Backend Server 1042 handles all the logic associated with storing and retrieving all data; e.g. Scheduling, Records, Registrations, Test/Quiz results, Users, and so on. The Backend Server 1042 also handles logic associated with administering tests/quizzes, performing authentication, authorization, and so on.

The Web service 1044 is a thin facade responsible for relaying data (such as student records, available courses, authentication, etc) between the SpeakENG Service 1024 and the Backend Server 1044. A portal 1046 delivers the Web pages to the browser 1026 to give most of the functionality that the web site provides that is not otherwise provided by the Client Site 1034, such as Scheduling, Test/Quiz taking, Course registration, Progress display, and so on.

The Lesson Content is stored in the data store 1052 as lesson files. As the student accesses the various lessons in a course, the appropriate lesson files are downloaded to the Lesson Content data store 1028. The lesson files are typically zipped up (e.g., .zip files) for easy downloading.

Various databases include: a Student Database 1054. This database stores of all data associated with a student; e.g., Lesson Progress, Placement Exam scores, Test/Quiz scores, the student's lesson access activity/history. A Scheduling Database 1056 stores the scheduling data that constitutes the schedules of all teachers and the times that students have scheduled sessions. An Evaluation Database 1058 contains evaluation content necessary to display and grade tests and quizzes. Typically, this data is stored as XML files, MP3 data, and images; of course, any other suitable data format is possible.

The teacher component 1006 comprises a computer 1006a on which a suitable browser 1062 can be executed to access the learning center 1004. A teacher-user can access the various databases 1054-1058 maintained at the learning center 1004. This allows the teacher to monitor and assess the student-user's progress through the learning material.

The computer 1006a can also launch a video conferencing engine 1064 in order to conduct a scheduled a live video conference between the teacher and the student, and in an embodiment of the present invention is a Skype™ client. As with the student's video conferencing engine, the teachers video conferencing engine 1064 receives video and possibly audio from the student. The video conferencing engine 1064 can also be configured to receive video from a digital camera aimed at the teacher and to send the captured video to the student. This is particularly useful for language learning, as it allows the teacher to visually demonstrate to the student how words are formed. The audio can be provided via a telephone or some other suitable communications channel.

A relay sever 1082 (e.g., the Skype™ supernode) mediates the communication (video and audio) between the two video conferencing engines 1036, 1064. In an embodiment of the present invention a conference database 1048 receives and stores video and audio feeds from the relay server 1082 which constitute a recording of the live video conference. These recordings can be accessed by the student or the teacher for review purposes, for evaluation and feedback of teacher effectiveness. The recording can be reviewed by the learning center personnel to evaluate teacher effectiveness.

As discussed above, an important aspect of the present invention is the integration of live video conferencing with the computer-assisted presentation of learning material. This requires scheduling a video session with the teacher. The student can request a video conference.

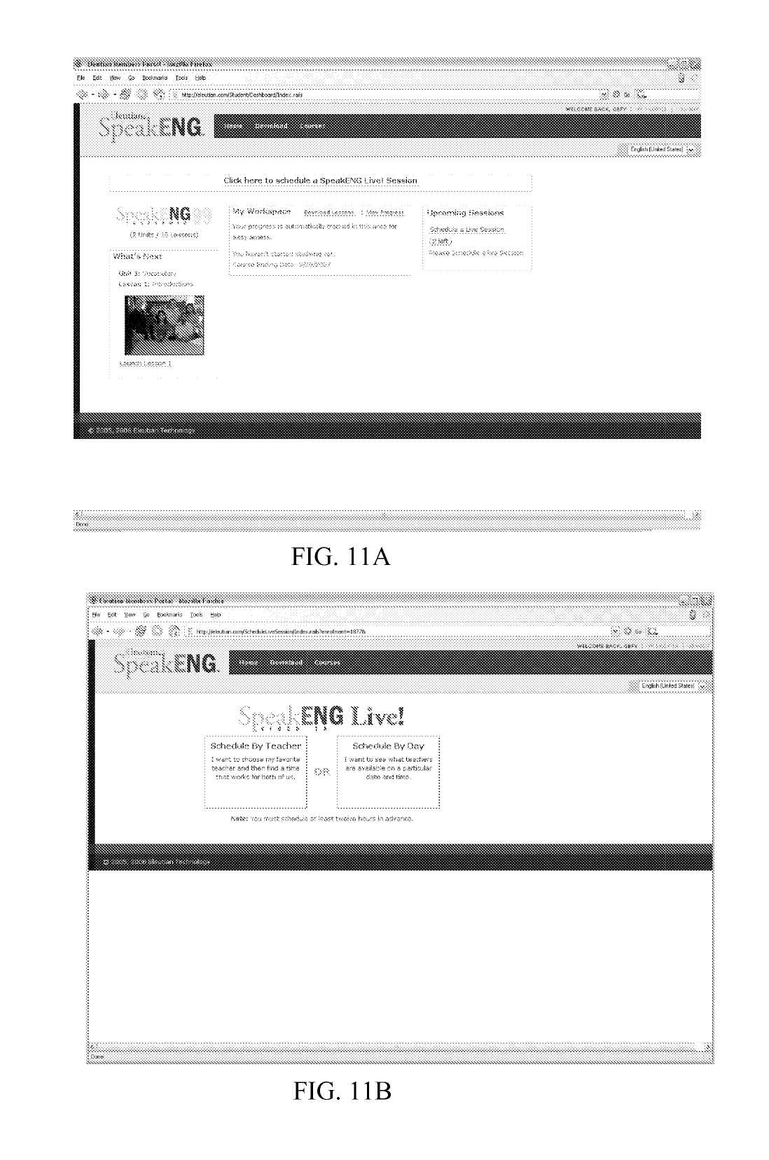

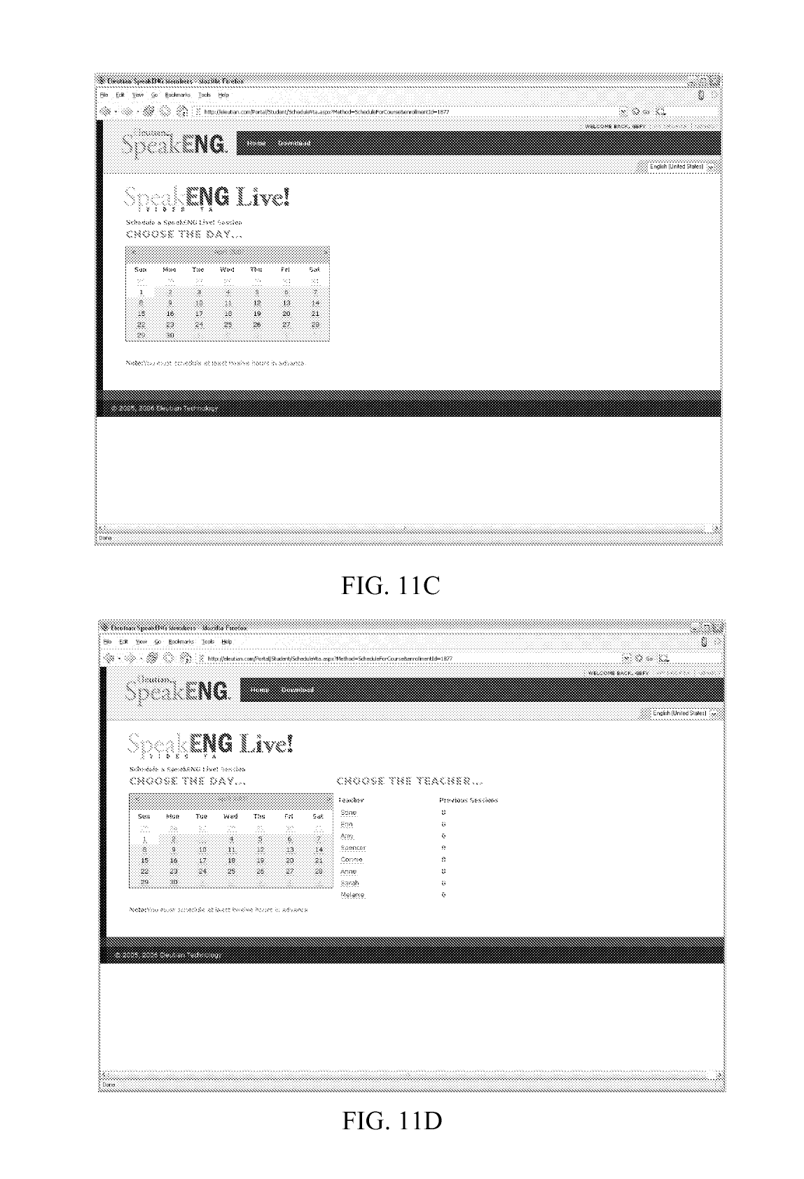

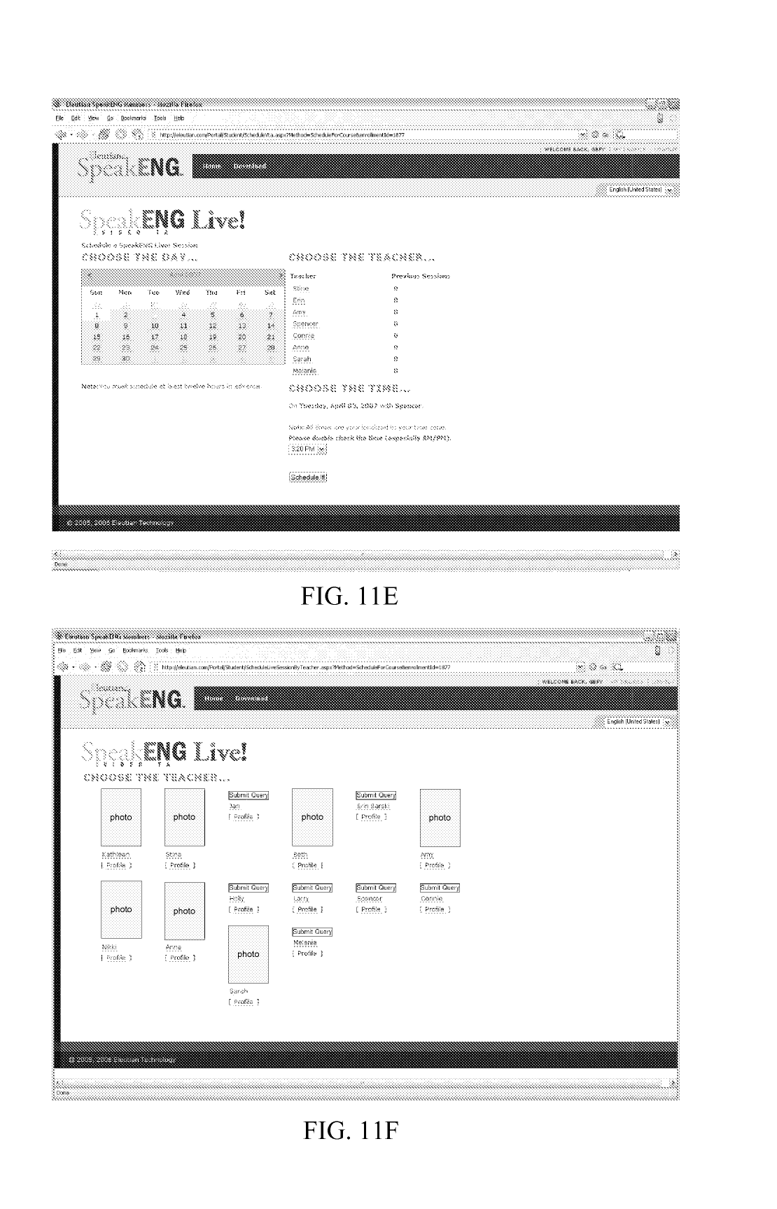

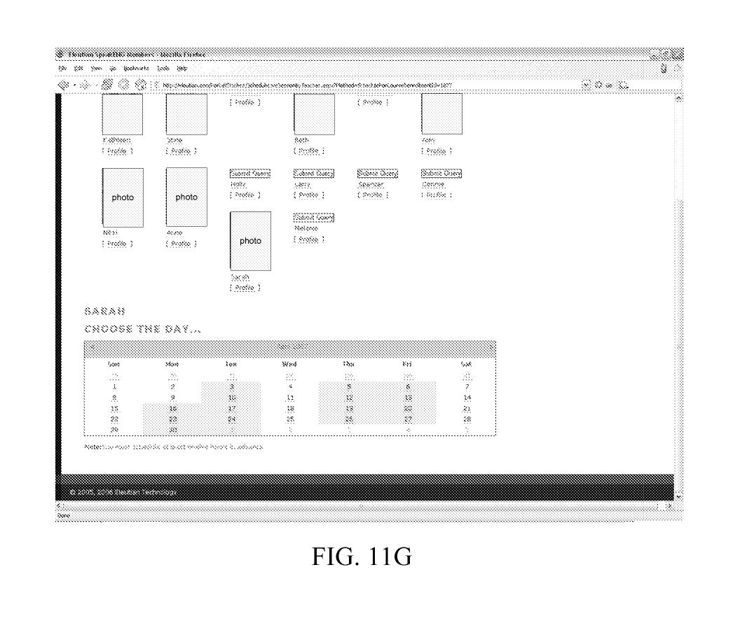

Referring to the screenshot of FIG. 11A, this screenshot shows the dashboard first presented in FIG. 3E, where the student is presented with a link in the “What's Next” portal to launch his selected lessons. A link called “Schedule a Live Session” is available in the “Upcoming Sessions” portal. This link leads to the page shown in the screenshot of FIG. 11B, where the student is presented with an option to schedule a live video conference by selecting a preferred time, or by selecting a preferred teacher. FIGS. 11C and 11D show the two pages that are displayed when the student selects a preferred time. FIG. 11C presents a calendar graphic, with links that the student can click on to advance the month (“>” and “<”) or to select a day of the month. FIG. 11D shows the available teachers for the selected date. The student can select an available teacher. FIG. 11E presents additional scheduling information when the student selects a teacher. The student is prompted with a drop-down menu to further select the time of day. A button to “schedule it” allows the student to submit the requested schedule. When the requested schedule is requested, the following general sequence of events will happen:
1. The schedule information gets stored in the scheduling database 1056.
2. The teacher is informed of this session on her schedule.
3. The student sees this session on his dashboard (provided from the learning center 1004), which displays a list of his upcoming sessions as well as a countdown to his next scheduled session.
4. The student's dashboard notifies the student he should start Skype™ when it is close to time for the session.
5. At the time scheduled for the session, the teacher will click a link on her teacher portal (provided from the learning center 1004) to make a call via Skype™ to the student, thus establishing a live video conference.

Referring now to FIGS. 11B, 11F, and 11G. The student can schedule a video conference based on a preferred teacher. Doing so will bring the student to the page shown in the screenshot of FIG. 11F, where list of available teachers are displayed. Each teacher is represented by a photo that he or she has selected to present to the students. The screenshots in these figures are taken from a “live” system, and so the photos have been obscured as they are intended only for registered students. The teacher's name and profile information is displayed with each photo. The profile information brings up a page that provides some information about the teacher, including educational background, teaching experience, and any personal interests or information that the teacher desires to share with the students. The teacher's name is a link to times when the teacher is available. FIG. 11G shows the available times for “Sarah” for the month of April. Links allow the student to advance to other months of the year.

The teacher's availability may vary as teaching assignments change or unexpected events happen. The teacher can log into the learning center and alter his or her schedule accordingly. Changes in the teacher's schedule are reflected each time a student brings up a scheduling menu. For example, in FIG. 11D, the list of available teachers may vary, if a teacher becomes available for a given day, or no longer is available on a given day. Similarly, in FIG. 11G, each teacher's calendar may vary as his or her availability changes.

What is claimed is:

1. A method for presentation of learning material comprising in a server steps of:
communicating learning material over the Internet to a student-user;
receiving progress information over the Internet indicative of the student-user's progress through the learning material; and
scheduling a video conference session between the student-user and the teacher-user.

2. The method of claim 1 wherein the scheduling based on the student-user's progress information.

3. The method of claim 2 wherein the progress information comprises one or more of interaction activity of the student-user with the learning material, or the time it takes for the student-user to complete portions of the learning material, or the student-user's test responses to a series of test questions.

4. The method of claim 3 wherein the student-user's interaction activity with the educational content includes durations of time that the student-user had expended on various portions of the learning material.

5. The method of claim 1 further comprising storing the video conference session, in order to monitor the video conference session.

6. The method of claim 1 further comprising communicating a recommendation over the Internet to the student-user, the recommendation being a suggestion to conduct a video conference session with a teacher-user, the recommendation based at least on the student-user's progress information.

7. The method of claim 1 further comprising scheduling a video conference session between the student-user and another student-user.

8. The method of claim 1 further comprising sending to the teacher-user the student-user's interaction activity with the educational material.

9. The method of claim 1 further comprising sending to the teacher-user information relating to previous video conference sessions between the student-user and other teacher-users.

10. A method of presenting educational material comprising:
sending educational content to a student-user over a communication network to a computer of the student-user, wherein the student-user interacts with the educational content;
receiving over the communication network information representative of the student-user's interaction activity with the educational content;
administering tests to the student-user, including:
(a) sending test material to the student-user over the communication network to the computer, wherein the test material is presented to the student-user and the student-user provides test responses thereto;
(b) receiving over the communication network the test responses; and
(c) storing the received test responses;
sending the received test responses of the student-user to a teacher-user; and
scheduling a video conference between the student-user and the teacher-user.

11. The method of claim 10 wherein the scheduling is performed based on the student-user's test responses.

12. The method of claim 10 wherein the scheduling is performed based on the student-user's interaction activity with the educational content.

13. The method of claim 10 further comprising scheduling a video conference between the student-user and another student-user.

14. The method of claim 10 wherein the student-user's interaction activity with the educational content includes durations of time that the student-user had expended on various portions of the educational content.

15. The method of claim 10 further comprising sending a recommendation to the student-user to schedule in a video conference with the teacher-user.

16. The method of claim 15 wherein the recommendation is made based at least on the test responses of the student-user or on the student-user's interaction activity with the educational material.

17. The method of claim 10 further comprising sending to the teacher-user the student-user's interaction activity with the educational material.

18. The method of claim 10 further comprising sending to the teacher-user information relating to previous video conferences between the student-user and other teacher-users.

19. The method of claim 10 further comprising storing a video conference session conducted between the student-user and the teacher-user.

20. A method for computer-based, teacher assisted instruction comprising:
from a server, sending learning material to one or more students, the learning material being received by students' computers;
at the server, receiving from each student's computer information pertaining to portions of the learning material accessed by said each student, including time spent by said each student at various portions of the learning material that had been accessed by said each student;
at the server, administering tests to the students including receiving, at the server, test responses from each student's computer;
at the server, computing and storing students' test results based on respective students' test responses; and
at the server, scheduling a video conference among the students and teachers.

21. The method of claim 20 wherein the scheduling includes scheduling a video conference between a first student and a first teacher.

22. The method of claim 21 wherein scheduling a video conference between the first student and the first teacher is based on one or more of the first student's test results or information about the first student pertaining to portions of the learning material accessed by the first student, including time spent by the first student at various portions of the learning material that had been accessed by the first student.

23. The method of claim 20 wherein the scheduling includes scheduling a video conference between a first plurality of students and a first teacher.

24. The method of claim 20 wherein the scheduling includes scheduling a video conference between a first student and at least a second student.

25. The method of claim 20 wherein scheduling a video conference for a first student and a first teacher is performed based on the information pertaining to portions of the learning material accessed by the first student, including time spent by the first student at each portion of the learning material accessed by the first student.

26. A method for presentation of learning material over the Internet comprising:
communicating learning material to a student-user's computer device;
receiving from the student-user's computing device progress information indicative of a student-user's progress through the learning material;
storing the progress information in a student database; and
scheduling a video conference between the student-user and the teacher-user.

27. The method of claim 26 wherein the learning material is stored in a learning material database located with a server, wherein the learning material is communicated from the server to the student-user computer.

28. The method of claim 27 wherein the student database is located with the server.

29. The method of claim 26 scheduling a video conference between the student-user and the teacher-user based at least on the student-user's progress information.

30. The method of claim 26 further comprising making a recommendation to schedule a video conference between the student-user and the teacher based at least on the student-user's progress information.

31. The method of claim 26 further comprising communicating test material to the student-user's computer device in order to administer a test, and receiving test responses from the student-user's computer device.

32. The method of claim 31 wherein the scheduling is based on the student-user's test responses.
